(19) United States
(12) Patent Application Publication
(10) Pub. No.: US 2020/0356934 A1
(43) Pub. Date: Nov. 12, 2020

(54) CUSTOMER SERVICE ASSISTANCE APPARATUS, CUSTOMER SERVICE ASSISTANCE METHOD, AND COMPUTER-READABLE RECORDING MEDIUM

(71) Applicant: NEC CORPORATION, Tokyo (JP)

(72) Inventors: Junko WATANABE, Tokyo (JP); Hiromi YAMAGUCHI, Tokyo (JP); Shinji NAKADAI, Tokyo (JP)

(73) Assignee: NEC CORPORATION, Tokyo (JP)

(21) Appl. No.: 16/762,008

(22) PCT Filed: Nov. 6, 2018
(86) PCT No.: PCT/JP2018/041088

§ 371 Date: May 6, 2020

(30) Foreign Application Priority Data
Nov. 7, 2017 (JP) 2017-215058

(51) Int. Cl. G06Q 10/06; G06N 20/00; G06K 9/00; G06Q 30/02

(52) U.S. Cl. CPC G06Q 10/06316; G06Q 30/0281; G06K 9/00342; G06N 20/00

(57) ABSTRACT

A customer service assistance apparatus 10 is provided with a video image acquisition unit 11 that acquires a video image of the inside of a store, a movement path acquisition unit 12 that acquires a movement path of a customer in the store, based on the acquired video image, a purchase action inference unit 13 that applies the acquired movement path to a prediction model for predicting a purchase action result based on a customer's movement path, and a transmission unit 14 that transmits the inferred probability to a terminal apparatus that is used by a store salesperson of the store.

### TECHNICAL FIELD

The present invention relates to a customer service assistance apparatus and a customer service assistance method for assisting a store salesperson in a store in serving a customer, and in particular relates to a computer-readable recording medium in which programs for realizing these are recorded.

### BACKGROUND ART

In recent years, due to developments in IT (Information Technology), various systems for assisting a store salesperson in serving a customer in a retail store have been proposed (for example, see Patent Documents 1 to 3). According to such systems, a store salesperson can efficiently serve a customer compared with a conventional system.

Patent Document 1 discloses a system for transmitting information regarding a customer's taste to a terminal apparatus of a store salesperson. Specifically, when a customer enters a store, the system disclosed in Patent Document 1 specifies the customer based on an image of the customer entering the store, and extracts taste information of the specified customer (for example, attribute information and purchase history of the customer) from a database. The system disclosed in Patent Document 1 then transmits the extracted taste information to a terminal apparatus of a store salesperson, and presents the extracted taste information on the screen of the terminal apparatus. According to the system disclosed in Patent Document 1, the store salesperson can be aware of the customer's tastes, and thus can efficiently serve the customer.

In addition, Patent Document 2 discloses a system for distributing product-related content to a customer's terminal and a store salesperson's terminal. Specifically, the system disclosed in Patent Document 2 transmits content related to a recommended product (a catalog of products, etc.), to a customer's terminal, and transmits a reason for recommending the product to the customer, to a store salesperson's terminal.

For example, assume that the system disclosed in Patent Document 2 has distributed content “XXX bag XXX series of brand XXX” to a customer's terminal. In this case, the system disclosed in Patent Document 2 transmits, to a store salesperson's terminal, a message “XXX is a brand that is highly popular among married ladies in their forties, and is a customer's favorite brand. XXX bag XXX series is a highly popular item. This customer purchases about two bags a year, and it is about time for this customer to purchase a new one”, for example.

When such a message is received by the terminal and is displayed on the screen of the terminal, the store salesperson checks the message. As a result, the store salesperson can confirm a specific reason for recommending the product to the customer, and thus, can efficiently serve the customer in this case as well.

Furthermore, Patent Document 3 discloses a system for analyzing a customer's movement. Specifically, the system disclosed in Patent Document 3 first acquires image information and distance information output from a 3D camera for shooting an image of a product shelf and a customer positioned in front of the product shelf. The system disclosed in Patent Document 3 then specifies a product that is held in a hand of a customer based on the acquired information, and analyzes a customer's movement toward the product based on the ID of the specified product, the position thereof at the point in time (the position of the shelf where the product was located), the time, and the like.

According to information obtained through this analysis, the store can be aware of which shelf and which row in the shelf a product that is frequently touched by customers is located in, and thus can achieve better shelf allocation. In addition, by using this information, the store can specify a change in customers' movement before and after distribution of flyers and before and after an advertisement, and, thus can also understand effects of distribution of flyers and an advertisement. Therefore, also with the use of the system disclosed in Patent Document 3, a store salesperson can efficiently serve a customer.

### LIST OF RELATED ART DOCUMENTS

### Patent Document

Patent Document 1: Japanese Patent Laid-Open Publication No. 2017-004432
Patent Document 2: Japanese Patent Laid-Open Publication No. 2015-219784
Patent Document 3: International Publication WO2015/033577

### SUMMARY OF INVENTION

### Problems to be Solved by the Invention

Incidentally, what is important in a store is to specify a customer that is highly motivated to purchase a product, and serve this customer. 1n particular, nowadays, concerns have been expressed regarding a shortage of workers, and there are cases where there too few salespersons in a store, and thus, specifying a customer highly motivated to purchase a product is very important from a managerial perspective. Therefore, there is demand for a system that assists in customer service to specify a customer that is highly motivated to purchase a product.

However, the system disclosed in Patent Document 1 only presents information regarding a customer's taste to a store salesperson, and the degree to which the customer is motivated to purchase a product is not presented to the store salesperson. Even if the system disclosed in Patent Document 1 is used, the degree to which the customer is motivated to purchase a product is left to the discretion of the store salesperson, and it is difficult to specify a customer Who is highly motivated to purchase a product.

In addition, the system disclosed in Patent Document 2 transmits a reason for recommending a product to a customer, to a store salesperson's terminal. However, the system disclosed in Patent Document 2 does not additionally transmit, to the store salesperson's terminal, the degree to which the customer is motivated to purchase a product, and thus, even if this system is used, it is difficult to specify a customer who is highly motivated to purchase a product.

In addition, a system disclosed in Patent Document 3 has a function of analyzing customer's actions. However, in order to specify a customer who is highly motivated to purchase a product, the analyzer needs to determine a customer's motivation for purchasing a product, based on the analysis result. In other words, even if the system disclosed in Patent Document 3 is used, it is difficult to specify a customer that is highly motivated to purchase a product.

An example object of the invention is to provide a customer service assistance apparatus, a customer service assistance method, and a computer-readable recording medium that make it possible to solve the above problems, and to improve customer service efficiency in a store by specifying a customer who is highly motivated to purchase a product.

### Means for Solving the Problems

In order to achieve the above-described example purpose, a customer service assistance apparatus according to an example aspect of the invention includes:

a video image acquisition unit configured to acquire a video image of the inside of a store;

a movement path acquisition unit configured to acquire a movement path of a customer in the store, based on the acquired video image;

a purchase action inference unit configured to apply the acquired movement path to a prediction model for predicting a purchase action result based on a customer's movement path, and infer a probability that the customer will make a purchase action; and

a transmission unit configured to transmit the inferred probability to a terminal apparatus that is used by a store salesperson of the store.

In addition, in order to achieve the above-described example purpose, a customer service assistance method according to an example aspect of the invention includes:

(a) a step of acquiring a video image of the inside of a store;

(b) a step of acquiring a movement path of a customer in the store, based on the acquired video image;

(c) a step of applying the acquired movement path to a prediction model for predicting a purchase action result based on a customer's movement path, and inferring a probability that the customer will make a purchase action; and

(d) a step of transmitting the inferred probability to a terminal apparatus that is used by a store salesperson of the store.

Furthermore, in order to achieve the above-described example purpose, a computer-readable recording medium according to an example aspect of the invention includes a program recorded thereon; the program including instructions that cause a computer to carry out:

(a) a step of acquiring a video image of the inside of a store;

(b) a step of acquiring a movement path of a customer in the store, based on the acquired video image;

(c) a step of applying the acquired movement path to a prediction model for predicting a purchase action result based on a customer's movement path, and inferring a probability that the customer will make a purchase action; and

(d) a step of transmitting the inferred probability to a terminal apparatus that is used by a store salesperson of the store.

### Advantageous Effects of the Invention

As described above, according to the present invention, it is possible to improve customer service efficiency in a store by specifying a customer who is highly motivated to purchase a product.

### BRIEF DESCRIPTION OF THE DRAWINGS

FIG. 1 is a block diagram illustrating a schematic configuration of a customer service assistance apparatus according to an example embodiment of the invention.

FIG. 2 is a block diagram illustrating a configuration of the customer service assistance apparatus according to an example embodiment of the invention in detail.

FIG. 3 is a layout diagram illustrating an example of layout of a store in which a customer is served according to an example embodiment of the invention.

FIG. 4 is a diagram for illustrating processing for acquiring a movement path, which is performed according to an example embodiment of the present invention.

FIG. 5 is a diagram illustrating an example of movement path data acquired according to an example embodiment of the present invention.

FIG. 6 is a diagram illustrating an example of training data that is used according to an example embodiment of the present invention.

FIG. 7 is an explanatory diagram illustrating a state of a store salesperson that is assisted by the customer service assistance apparatus according to an example embodiment of the invention to serve a customer.

FIG. 8 is a flowchart illustrating operations of the customer service assistance apparatus according to an example embodiment of the invention.

FIG. 9 is a block diagram illustrating an example of a computer that realizes the customer service assistance apparatus according to an example embodiment of the invention.

### EXAMPLE EMBODIMENT

### Example Embodiment

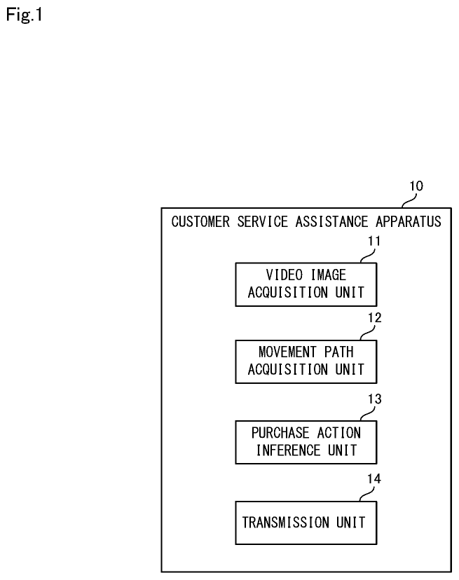

A customer service assistance apparatus, a customer service assistance method, and a program in an example embodiment of the invention will be described below with reference to FIGS. 1 to 9.

[Apparatus Configuration]

First, a schematic configuration of the customer service assistance apparatus in this example embodiment will be described with reference to FIG. 1. FIG. 1 is a block diagram illustrating a schematic configuration of the customer service assistance apparatus in the example embodiment of the invention.

A customer service assistance apparatus 10 according to this example embodiment illustrated in FIG. 1 is an apparatus for assisting a store salesperson in serving a customer in a store. As illustrated in FIG. 1, the customer service assistance apparatus 10 according to this example embodiment is provided with a video image acquisition unit 11, a movement path acquisition unit 12, a purchase action inference unit 13, and a transmission unit 14.

The video image acquisition unit 11 acquires a video image of the inside of a store. The movement path acquisition unit 12 acquires a movement path of a customer in the store, based on a video image acquired by the video image acquisition unit 11. The purchase action inference unit 13 applies the movement path acquired by the movement path acquisition unit 12 to a prediction model for predicting a purchase action result based on a customer's movement path, and infers a degree of possibility (probability) that the customer will make a purchase action. The transmission unit 14 transmits the probability inferred by the purchase action inference unit 13 to a terminal apparatus used by a store salesperson of the store.

As described above, in this example embodiment, the possibility that a customer will purchase a product is inferred as a numerical value based on a movement path of the customer in the store, and a store salesperson is notified of the inference result. Therefore, according to this example embodiment, a store salesperson can easily specify a customer who is highly motivated to purchase a product, and thus customer service efficiency in the store is improved.

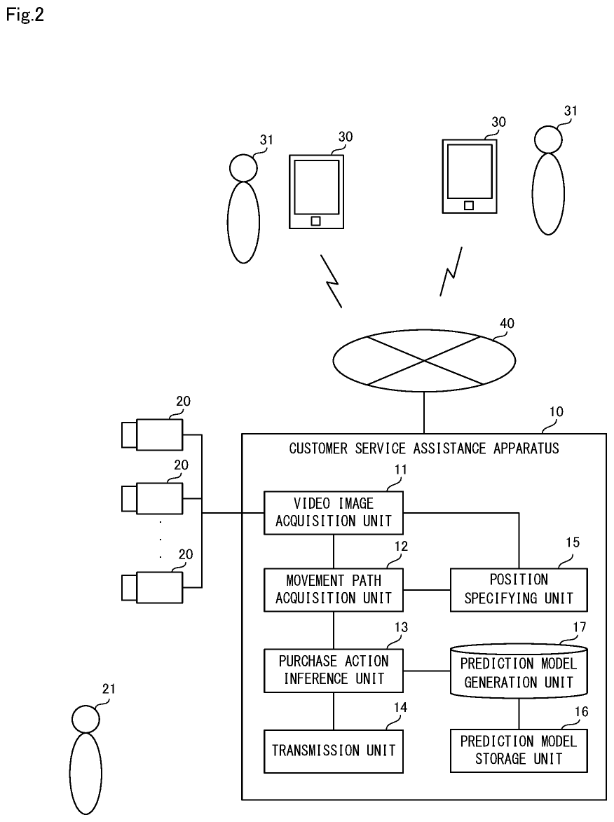

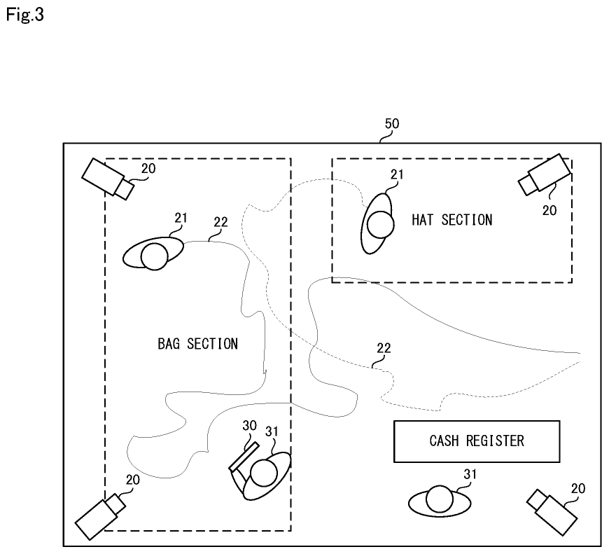

Next, the configuration of the customer service assistance apparatus 10 according to this example embodiment will be described in more detail with reference to FIGS. 2 to 7. FIG. 2 is a block diagram illustrating the configuration of the customer service assistance apparatus according to the example embodiment of the invention in detail, FIG. 3 is a layout diagram illustrating an example of the layout of a store in which a customer is served according to the example embodiment of the invention.

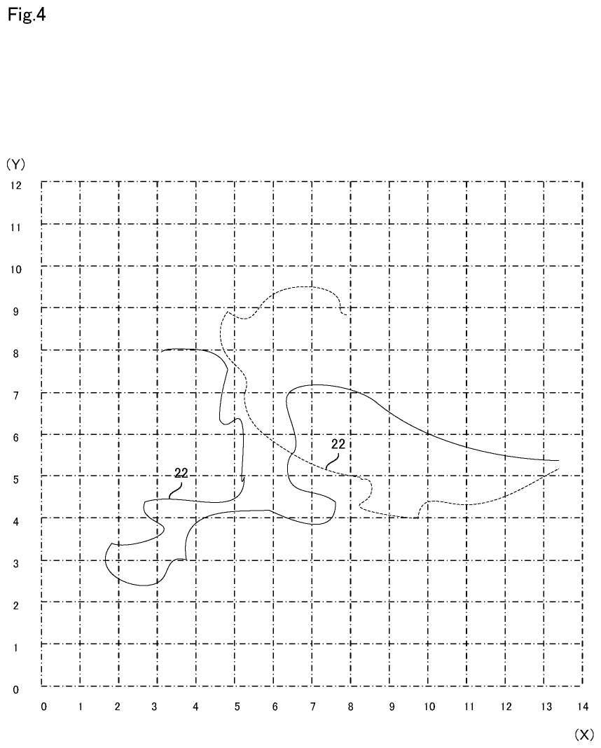

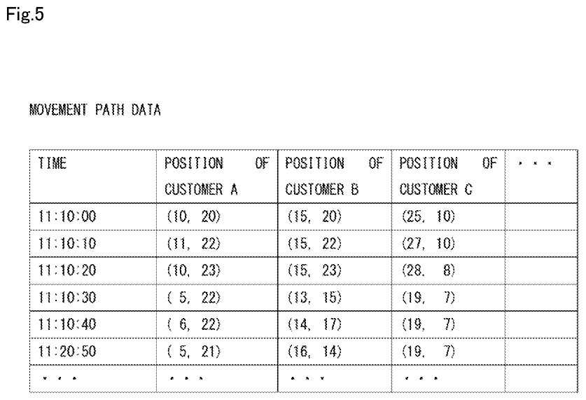

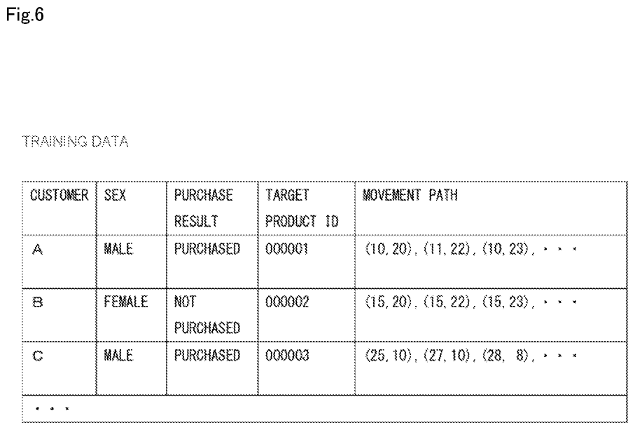

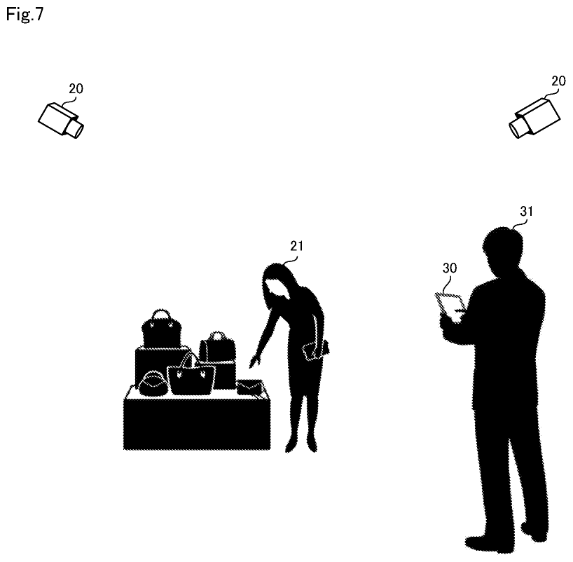

FIG. 4 is a diagram for illustrating processing for acquiring a movement path that is performed according to the example embodiment of the present invention. FIG. 5 is a diagram illustrating an example of movement path data acquired according to the example embodiment of the present invention. FIG. 6 is a diagram illustrating an example of training data that is used according to the example embodiment of the present invention. FIG. 7 is an explanatory diagram illustrating a state of a store salesperson that is assisted by the customer service assistance apparatus according to the example embodiment of the invention in serving a customer.

First, as illustrated in FIGS. 2 and 3, a plurality of cameras 20 are installed inside a store 50. Each of the cameras 20 shoots an image of a corresponding region in the store 50, and outputs video image data of the shot region.

In addition, as illustrated in FIG. 2, in this example embodiment, the customer service assistance apparatus 10 is connected to the plurality of cameras 20, and the video image acquisition unit 11 acquires video image data output from each of the plurality of cameras 20. In addition, the customer service assistance apparatus 10 is connected to a terminal apparatus 30 that is used by a store salesperson 31 of the store 50 via a network 40, to enable data communication.

Furthermore, as illustrated in FIG. 2, in this example embodiment, the customer service assistance apparatus 10 is provided with a position specifying unit 15, a prediction model generation unit 16, and a prediction model storage unit 17, in addition to the video image acquisition unit 11, the movement path acquisition unit 12, the purchase action inference unit 13, and the transmission unit 14 that have been described above.

In this example embodiment, when a customer 21 appears in video image data acquired by one of the cameras 20, the movement path acquisition unit 12 extracts feature amounts of the customer 21, and tracks the customer 21 based on the extracted feature amounts. At this time, when the customer moves out of frame from video image data of one camera, the movement path acquisition unit 12 detects the feature amounts from video image data of another camera, and continues to track the customer 21. The result of tracking performed by the movement path acquisition unit 12 is as shown in FIG. 3. In FIG. 3, reference numeral 22 indicates a movement path of the customer 21.

The movement path acquisition unit 12 then specifies the position of the customer 21 that is being tracked in the store 50 based on installation positions and shooting directions of cameras registered in advance, and the position the customer 21 on the screen, and records the specified position of the customer 21 in time series. Specifically, as illustrated in FIG. 4, coordinate axes (the X axis and the Y axis) are set in the store 50 in advance. Therefore, as illustrated in FIG. 5, the movement path acquisition unit 12 specifies coordinates of each customer 21 at a set interval, and records the specified coordinates (X,Y) in time series. This recorded data is used as movement path data for specifying a movement path of the customer 21.

The prediction model generation unit 16 generates a prediction model by performing machine learning using a movement path of a customer and related purchase results as training data. In addition, the prediction model generation unit 16 can also use, in machine learning, other factors that can affect a purchase result, in addition to the movement path of the customer. The generated prediction model is stored in the prediction model storage unit 17.

Specifically, data acquired in the past and data created experimentally are used as training data. In the example in FIG. 6, the training data is data acquired in the past, and is constituted by a sex, a purchase result, a target product ID, and a movement path of each customer, for example. In addition, a movement path is constituted by coordinates of a customer in the store recorded in time series. Furthermore, training data may also include information that is not illustrated in FIG. 6, such as personal information of the customer.

In addition, the prediction model generation unit 16 extracts feature amounts from a movement path in each row of training data, inputs the extracted feature amounts, a sex, a purchase result, and a target product ID to a machine learning engine, and executes machine learning. Alternatively, the prediction model generation unit 16 may also execute machine learning based on a movement path and the like in training data and a purchase result. An existing machine learning engine can be used as the machine learning engine. A prediction model generated through such machine learning is a statistical model, and, when movement path data is input thereto, the probability that the customer 21 will purchase a product is output.

In addition, in the examples in FIGS. 4 and 5, a movement path is specified according to coordinates, but this example embodiment is not limited to such examples. For example, movement path data may also be generated by dividing a store into a plurality of areas, and recording a time period during which or the number of times a customer is present in each area.

In addition, the position specifying unit 15 first acquires, from the terminal apparatus 30 that is used by the store salesperson 31 of the store 50, positional information for specifying the position of the terminal apparatus 30, and specifies the position of the store salesperson 31 based on the acquired positional information. Specifically, if provided with a GPS receiver, the terminal apparatus 30 creates positional information based on a received GPS signal. Also, if connected to the wireless LAN of the store 50, the terminal apparatus 30 creates positional information based on the position of an access point of the wireless LAN to which the terminal apparatus 30 is connected. The position specifying unit 15 acquires positional information created in this manner, from the terminal apparatus 30, and specifies the position of the store salesperson 31 that holds this terminal apparatus 30.

In addition, the position specifying unit 15 can also specify the position of the store salesperson 31 based on video image data acquired by a camera 20. Specifically, the position specifying unit 15 detects and tracks the store salesperson 31 by comparing feature amounts extracted from video image data with feature amounts indicating the store salesperson 31 and prepared in advance. The position specifying unit 15 then specifies the position of the store salesperson 31 in the store 50 that is being tracked, based on installation positions and shooting directions of cameras registered in advance, and the position of the store salesperson 31 on the screen.

Also, the position specifying unit 15 specifies the position of the customer 21 based on a movement path of the customer 21 acquired by the movement path acquisition unit 12. Furthermore, the position specifying unit 15 notifies the purchase action inference unit 13 of the specified positions of the store salesperson 31 and the customer 21.

In this example embodiment, if the relationship between the position of the customer 21 and the position of the store salesperson 31 satisfies a set condition, the purchase action inference unit 13 infers the probability that the customer 21 that satisfies a set condition will make a purchase action. Examples of the set condition include the distance between the customer 21 and the store salesperson 31 being shorter than or equal to a threshold. In addition, a configuration may also be adopted in which the purchase action inference unit 13 measures, using the movement path data acquired by the movement path acquisition unit 12, the number of times the customer 21 has approached the store salesperson 31 by a certain distance, and infers the possibility that the customer 21 will make a purchase action, using, as a set condition, the measured number of times being larger than or equal to a threshold.

In addition, in this example embodiment, the purchase action inference unit 13 infers the probability that a target customer will make a purchase action, by applying movement path data acquired by the movement path acquisition unit 12 to the prediction model stored in the prediction model storage unit 17. Furthermore, when there is a plurality of customers 21 in the store 50, the purchase action inference unit 13 infers a probability for each of the customers 21.

The transmission unit 14 transmits the probability inferred by the purchase action inference unit 13, to the terminal apparatus 30 that is used by the store salesperson 31 of the store 50. Accordingly, as illustrated in FIG. 7, the store salesperson 31 of the store 50 can check the probability that the customer 21 will make a purchase action, on the screen of the terminal apparatus 30.

In addition, in this example embodiment, if there are a plurality of customers 21 for which probability has been inferred, the transmission unit 14 specifies a customer 21 with the highest probability. The transmission unit 14 then transmits information regarding the specified customer 21 and the inferred probability, to the terminal apparatus 30 that is used by the store salesperson 31 of the store 50. Accordingly, the store salesperson 31 can efficiently serve the customer.

[Apparatus Operations]

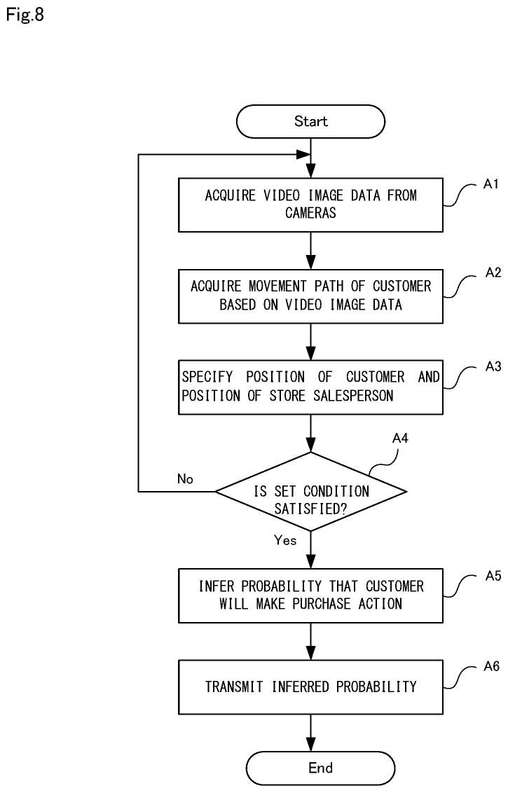

Next, operations of the customer service assistance apparatus 10 according to this example embodiment will be described with reference to FIG. 8. FIG. 8 is a flowchart illustrating operations of the customer service assistance apparatus according to the example embodiment of the invention. In the following description, FIGS. 1 to 7 will be referred to as appropriate. In addition, in this example embodiment, a customer service assistance method is implemented by causing the customer service assistance apparatus 10 to operate. Therefore, description of the customer service assistance method according to this example embodiment is replaced with the following description of operations of the customer service assistance apparatus 10.

First, assume that the prediction model generation unit 16 generates a prediction model by performing machine learning using training data. The prediction model generation unit 16 then stores the generated prediction model to the prediction model storage unit 17.

As illustrated in FIG. 8, first, the video image acquisition unit 11 acquires video images from the cameras 20 (step A1). Specifically, in step A1, the video image acquisition unit 11 acquires frames that make up video image data for a set time period, from each of the cameras 20.

Next, the movement path acquisition unit 12 acquires a movement path of the customer 21 located in the store 50, based on the video images acquired in step A1 (step A2). Specifically, the movement path acquisition unit 12 tracks the customer 21 using the video images acquired using the cameras 20, and records the positions of the customer 21 in time series. Accordingly, movement path data (see FIG. 5) is created.

Next, the position specifying unit 15 specifies the position of the customer 21 and the position of the store salesperson 31 in the store 50 (step A3), Specifically, in step A3, the position specifying unit 15 specifies the position of the store salesperson 31 based on positional information acquired from the terminal apparatus 30. Also, the position specifying unit 15 specifies the position of the customer 21 based on the movement path of the customer 21 acquired in step A2.

Next, the purchase action inference unit 13 determines whether or not the relationship between the position of the customer 21 and the position of the store salesperson 31 specified in step A3 satisfies a set condition (step A4). Specifically, in step A4, the purchase action inference unit 13 determines whether or not the distance between the customer 21 and the store salesperson 31 is shorter than or equal to a threshold, for example.

As a result of the determination in step A4, if the set condition is not satisfied, step A1 is executed again by the video image acquisition unit 11. On the other hand, as a result of the determination in step A4, if the set condition is satisfied, the purchase action inference unit 13 applies the movement path of a customer 21 that satisfies the set condition, to the prediction model, and infers the probability that this customer 21 will make a purchase action (step A5).

Next, the transmission unit 14 transmits the probability inferred in step A5, to the terminal apparatus 30 that is used by the store salesperson 31 of the store 50 (step A6). In addition, if there are a plurality of customers 21 for which probability has been inferred in step A5, the transmission unit 14 specifies a customer 21 with the highest probability. The transmission unit 14 then transmits information regarding the specified customer 21 and the inferred probability, to the terminal apparatus 30 that is used by the store salesperson 31.

By executing step A6, as illustrated in FIG. 7, the store salesperson 31 can check, on the screen of the terminal apparatus 30, the probability that the customer 21 will make a purchase action. In addition, once a set period of time has elapsed after the execution of step A6, step A1 is executed again.

[Effects of First Example Embodiment]

As described above, in this example embodiment, the store salesperson 31 can check, on the screen of the terminal apparatus 30, the probability that the customer 21 that the store salesperson 31 is facing will purchase a product. In addition, if there are a plurality of customers 21, a customer with a high probability of purchasing a product can be determined in one glance. Therefore, according to this example embodiment, a store salesperson can easily specify a customer that is highly motivated to purchase a product, and thus customer service efficiency in the store is improved.

[Program]

A program in this example embodiment may be any program that causes a computer to execute steps A1 to A6 illustrated in FIG. 8. By installing this program in a computer, and executing this program, the customer service assistance apparatus 10 and the customer service assistance method in this example embodiment can be realized. In this case, a processor of the computer functions as the video image acquisition unit 11, the movement path acquisition unit 12, the purchase action inference unit 13, the transmission unit 14, the position specifying unit 15, and the prediction model generation unit 16, and performs processing.

In addition, the program in this example embodiment may be executed by a computer system constituted by a plurality of computers. In this case, for example, each of the computers may function as one of the video image acquisition unit 11, the movement path acquisition unit 12, the purchase action inference unit 13, the transmission unit 14, the position specifying unit 15, and the prediction model generation unit 16.

(Physical Configuration)

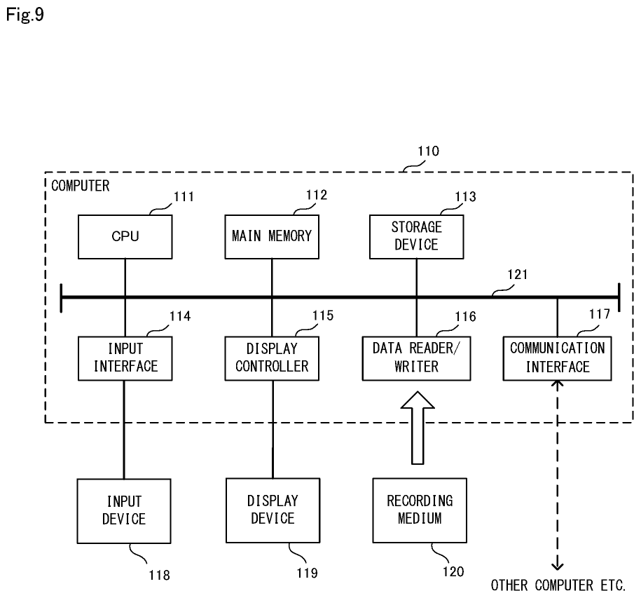

Here, a computer that realizes the customer service assistance apparatus by executing the programs in the example embodiment will be described with reference to FIG. 9. FIG. 9 is a block diagram illustrating an example of a computer that realizes the customer service assistance apparatuses in the example embodiment of the invention.

As illustrated in FIG. 10, a computer 110 is provided with a CPU (Central Processing Unit) 111, a main memory 112, a storage device 113, an input interface 114, a display controller 115, a data reader/writer 116, and a communication interface 117. These units are connected via a bus 121 to enable mutual data communication. Note that the computer 110 may also be provided with a GPU (Graphics Processing Unit) or an FPGA (Field-Programmable Gate Array) in addition to the CPU 111, or in place of the CPU 111.

The CPU 111 carries out various calculations by deploying programs (codes) according to the present example embodiment stored in the storage device 113 to the main memory 112, and executing these in a predetermined order. The main memory 112 is typically a volatile storage device such as a DRAM (Dynamic Random Access Memory). In addition, the programs in the present example embodiment are provided in a state of being stored in a computer-readable recording medium 120. Note that the programs in the present example embodiment may also be programs distributed on the Internet connected via the communication interface 117.

In addition, specific examples of the storage device 113 include a semiconductor storage device such as a flash memory, in addition to a hard disk drive. The input interface 114 mediates data transmission between the CPU 111 and an input device 118 such as a keyboard or a mouse. The display controller 115 is connected to a display device 119, and controls display on the display device 119.

The data reader/writer 116 mediates data transmission between the CPU 111 and the recording medium 120, reads out a program from the recording medium 120, and writes a processing result from the computer 110 to the recording medium 120. The communication interface 117 mediates data transmission between the CPU 111 and another computer.

In addition, specific examples of the recording medium 120 include general-purpose semiconductor storage devices such as a CF (Compact Flash (registered trademark)) and an SD (Secure Digital), magnetic recording media such as a flexible disk, and optical recording media such as a CD-ROM (Compact Disk Read Only Memory).

Note that the customer service assistance apparatuses according to the example embodiment can also be realized by using hardware items corresponding to the units instead of a computer in which the programs are installed. Furthermore, a configuration may also be adopted in which a portion of the customer service assistance apparatus is realized by a program, and the remaining portion is realized by hardware.

A portion or the entirety of the above example embodiments can be expressed as Supplementary notes 1 to 12 to be described below, but there is no limitation to the following description.

(Supplementary Note 1)

A customer service assistance apparatus comprising:

a video image acquisition unit configured to acquire a video image of the inside of a store;

a movement path acquisition unit configured to acquire a movement path of a customer in the store, based on the acquired video image;

a purchase action inference unit configured to apply the acquired movement path to a prediction model for predicting a purchase action result based on a customer's movement path, and infer a probability that the customer will make a purchase action; and

a transmission unit configured to transmit the inferred probability to a terminal apparatus that is used by a store salesperson of the store.

(Supplementary Note 2)

The customer service assistance apparatus according to Supplementary Note 1, further comprising:

a prediction model generation unit configured to generate the prediction model by performing machine learning using a customer's movement path and a related purchase result as training data.

(Supplementary Note 3)

The customer service assistance apparatus according to Supplementary Note 1 or 2,

wherein, if there are a plurality of customers for which the probability has been inferred, the transmission unit specifies a customer with the highest probability, and further transmits information regarding the specified customer to a terminal apparatus that is used by a store salesperson of the store.

(Supplementary Note 4)

The customer service assistance apparatus according to any one of Supplementary Note 1 to 3, further comprising

a position specifying unit configured to specify a position of the store salesperson of the store based on positional information for specifying a position of a terminal apparatus that is used by the store salesperson, and also specify a position of the customer based on the acquired movement path,

wherein the purchase action inference unit obtains a positional relation between the customer and the store salesperson based on the specified positions, and infers a probability that the customer for which the obtained positional relation satisfies a set condition will purchase a product.

(Supplementary Note 5)

A customer service assistance method comprising:

(a) a step of acquiring a video image of the inside of a store;

(b) a step of acquiring a movement path of a customer in the store, based on the acquired video image;

(c) a step of applying the acquired movement path to a prediction model for predicting a purchase action result based on a customer's movement path, and inferring a probability that the customer will make a purchase action; and

(d) a step of transmitting the inferred probability to a terminal apparatus that is used by a store salesperson of the store.

(Supplementary Note 6)

The customer service assistance method according to Supplementary Note 5, further comprising:

(e) a step of generating the prediction model by performing machine learning using a customer's movement path and a related purchase result as training data.

(Supplementary Note 7)

The customer service assistance method according to Supplementary Note 5 or 6,

wherein, in the (d) step, if there are a plurality of customers for which the probability has been inferred, a customer with the highest probability is specified, and information regarding the specified customer is further transmitted to a terminal apparatus that is used by a store salesperson of the store.

(Supplementary Note 8)

The customer service assistance method according to any one of Supplementary Notes 5 to 7, further comprising:

(f) a step of specifying a position of the store salesperson of the store based on positional information for specifying a position of a terminal apparatus that is used by the store salesperson, and also specifying a position of the customer based on the acquired movement path,

wherein, in the (c) step, a positional relation between the customer and the store salesperson is obtained based on the specified positions, and a probability that the customer for which the obtained positional relation satisfies a set condition will purchase a product is inferred.

(Supplementary Note 9)

A computer-readable recording medium that includes a program recorded thereon, the program including instructions that cause a computer to carry out:

(a) a step of acquiring a video image of the inside of a store;

(b) a step of acquiring a movement path of a customer in the store, based on the acquired video image;

(c) a step of applying the acquired movement path to a prediction model for predicting a purchase action result based on a customer's movement path, and inferring a probability that the customer will make a purchase action; and

(d) a step of transmitting the inferred probability to a terminal apparatus that is used by a store salesperson of the store.

(Supplementary Note 10)

The computer-readable recording medium according to Supplementary Note 9, the program further including an instruction that causes a computer to carry out:

(e) a step of generating the prediction model by performing machine learning using a customer's movement path and a related purchase result as training data.

(Supplementary Note 11)

The computer-readable recording medium according to Supplementary Note 9 or 10,

wherein, in the (d) step, if there are a plurality of customers for which the probability has been inferred, a customer with the highest probability is specified, and information regarding the specified customer is further transmitted to a terminal apparatus that is used by a store salesperson of the store.

(Supplementary Note 12)

The computer-readable recording medium according to any one of Supplementary Notes 9 to 11, the program further including an instruction that causes a computer to carry out:

(f) a step of specifying a position of the store salesperson of the store based on positional information for specifying a position of a terminal apparatus that is used by the store salesperson, and also specifying a position of the customer based on the acquired movement path,

wherein, in the (c) step, a positional relation between the customer and the store salesperson is obtained based on the specified positions, and a probability that the customer for which the obtained positional relation satisfies a set condition will purchase a product is inferred.

Although the present invention has been described above with reference to the example embodiments above, the invention is not limited to the above example embodiments. Various modifications understandable to a person skilled in the art can be made in configurations and details of the invention, within the scope of the invention.

This application is based upon and claims the benefit of priority from Japanese Patent Application No. 2017-215058, filed Nov. 7, 2017, the disclosure of which is incorporated herein in its entirety by reference.

### INDUSTRIAL APPLICABILITY

As described above, according to the invention, it is possible to improve customer service efficiency by specifying a customer that is highly motivated to purchase a product. The invention is useful to any application in which a store salesperson needs to serve a customer, without particular limitation.

### LIST OF REFERENCE SIGNS

10 Customer service assistance apparatus
11 Video image acquisition unit
12 Movement path acquisition unit
13 Purchase action inference unit
14 Transmission unit
15 Position specifying unit
16 Prediction model generation unit
17 Prediction model storage unit
20 Camera
21 Customer
22 Movement path
30 Terminal apparatus
31 Salesperson
40 Network
50 Store
110 Computer
111 CPU
112 Main memory
113 Storage apparatus
114 Input interface
115 Display controller
116 Data reader/writer
117 Communication interface
118 Input device
119 Display device
120 Recording medium
121 Bus

1. A customer service assistance apparatus comprising:
a video image acquisition unit configured to acquire a video image of the inside of a store;
a movement path acquisition unit configured to acquire a movement path of a customer in the store, based on the acquired video image;
a purchase action inference unit configured to apply the acquired movement path to a prediction model for predicting a purchase action result based on a customer's movement path, and infer a probability that the customer will make a purchase action; and
a transmission unit configured to transmit the inferred probability to a terminal apparatus that is used by a store salesperson of the store.

2. The customer service assistance apparatus according to claim 1, further comprising:
a prediction model generation unit configured to generate the prediction model by performing machine learning using a customer's movement path and a related purchase result as training data.

3. The customer service assistance apparatus according to claim 1,
wherein, if there are a plurality of customers for which the probability has been inferred, the transmission unit specifies a customer with the highest probability, and further transmits information regarding the specified customer to a terminal apparatus that is used by a store salesperson of the store.

4. The customer service assistance apparatus according to claim 1, further comprising
a position specifying unit configured to specify a position of the store salesperson of the store based on positional information for specifying a position of a terminal apparatus that is used by the store salesperson, and also specify a position of the customer based on the acquired movement path,
wherein the purchase action inference unit obtains a positional relation between the customer and the store salesperson based on the specified positions, and infers a probability that the customer for which the obtained positional relation satisfies a set condition will purchase a product.

5. A customer service assistance method comprising:
acquiring a video image of the inside of a store;
acquiring a movement path of a customer in the store, based on the acquired video image;
applying the acquired movement path to a prediction model for predicting a purchase action result based on a customer's movement path, and inferring a probability that the customer will make a purchase action; and
transmitting the inferred probability to a terminal apparatus that is used by a store salesperson of the store.

6. The customer service assistance method according to claim 5, further comprising:
generating the prediction model by performing machine learning using a customer's movement path and a related purchase result as training data.

7. The customer service assistance method according to claim 5,
wherein, in the transmitting, if there are a plurality of customers for which the probability has been inferred, a customer with the highest probability is specified, and information regarding the specified customer is further transmitted to a terminal apparatus that is used by a store salesperson of the store.

8. The customer service assistance method according to claim 5, further comprising:
specifying a position of the store salesperson of the store based on positional information for specifying a position of a terminal apparatus that is used by the store salesperson, and also specifying a position of the customer based on the acquired movement path,
wherein, in the (c) step, a positional relation between the customer and the store salesperson is obtained based on the specified positions, and a probability that the customer for which the obtained positional relation satisfies a set condition will purchase a product is inferred.

9. A non-transitory computer-readable recording medium that includes a program recorded thereon, the program including instructions that cause a computer to carry out:
acquiring a video image of the inside of a store;
acquiring a movement path of a customer in the store, based on the acquired video image;
applying the acquired movement path to a prediction model for predicting a purchase action result based on a customer's movement path, and inferring a probability that the customer will make a purchase action; and
transmitting the inferred probability to a terminal apparatus that is used by a store salesperson of the store.

10. The non-transitory computer-readable recording medium according to claim 9, the program further including an instruction that causes a computer to carry out:
generating the prediction model by performing machine learning using a customer's movement path and a related purchase result as training data.

11. The non-transitory computer-readable recording medium according to claim 9,
wherein, in the transmitting, if there are a plurality of customers for which the probability has been inferred, a customer with the highest probability is specified, and information regarding the specified customer is further transmitted to a terminal apparatus that is used by a store salesperson of the store.

12. The non-transitory computer-readable recording medium according to claim 9, the program further including an instruction that causes a computer to carry out:
specifying a position of the store salesperson of the store based on positional information for specifying a position of a terminal apparatus that is used by the store salesperson, and also specifying a position of the customer based on the acquired movement path,
wherein, in the (c) step, a positional relation between the customer and the store salesperson is obtained based on the specified positions, and a probability that the customer for which the obtained positional relation satisfies a set condition will purchase a product is inferred.
